(19) United States
(12) Patent Application Publication
(10) Pub. No.: US 2021/0250211 A1
(43) Pub. Date: Aug. 12, 2021

(54) Transmitting and Receiving Data Symbols

(71) Applicant: Telefonaktiebolaget LM Ericsson (publ), Stockholm (SE)

(72) Inventors: Miguel Lopez, Solna (SE); Dennis Sundman, Sollentuna (SE); Leif Wilhelmsson, Lund (SE)

(21) Appl. No.: 17/253,871

(22) PCT Filed: Jun. 25, 2018
(86) PCT No.: PCT/EP2018/066984

§ 371 Date: Dec. 18, 2020

(51) Int. Cl. H04L 27/02; H04L 27/26; H04W 52/02; H04L 27/30

(52) U.S. Cl. CPC H04L 27/02; H04L 27/30; H04W 52/0235; H04L 27/2607

(57) ABSTRACT

In one example aspect, a method is provided of transmitting a plurality of data symbols. The method comprises transmitting a first on-off keyed signal corresponding to the data symbols, the first signal comprising a plurality of on periods and a plurality of off periods. Each on period comprises a first signal portion cyclically shifted within the on period by a respective random or pseudorandom factor.

### TECHNICAL FIELD

Examples of the present disclosure relate to transmitting data symbols, for example where the data symbols comprise a Wake Up Packet (WUP).

### BACKGROUND

Wake-up receivers (WUR), sometimes also referred to as wake-up radios, provide a means to significantly reduce power consumption in receivers used in wireless communication. A WUR can be based on a very relaxed architecture, as it only needs to be able to detect the presence of a wake-up signal.

In some wireless communication devices, a WUR and another radio may share the same antenna. When the WUR is turned on and waiting for the wake up message, the other radio can be switched off to preserve energy. Once the wake up message is received by the WUR, it may wake up the other radio. The other radio may then be used for transmission and/or reception of data.

A commonly used modulation for a wake-up packet (WUP), i.e. the signal sent to the WUR, is on-off keying (OOK). OOK is a binary modulation, where a logical one is represented with sending a signal (ON) whereas a logical zero is represented by not sending a signal (OFF). A wake-up packet may be in the form of a particular sequence of data symbols that modulate an OOK signal.

### SUMMARY

One aspect of the present disclosure provides a method of transmitting a plurality of data symbols. The method comprises transmitting a first on-off keyed signal corresponding to the data symbols. The first signal comprises a plurality of on periods and a plurality of off periods. Each on period comprises a first signal portion cyclically shifted within the on period by a respective random or pseudorandom factor.

Another aspect of the present disclosure provides a method of receiving a plurality of data symbols. The method comprises receiving a first on-off keyed signal corresponding to the data symbols. The first signal comprises a plurality of on periods and a plurality of off periods. Each on period comprises a first signal portion cyclically shifted within the on period by a respective random or pseudorandom factor.

A further aspect of the present disclosure provides apparatus for transmitting a plurality of data symbols. The apparatus comprises a processor and a memory. The memory contains instructions executable by the processor such that the apparatus is operable to transmit a first on-off keyed signal corresponding to the data symbols. The first signal comprises a plurality of on periods and a plurality of off periods. Each on period comprises a first signal portion cyclically shifted within the on period by a respective random or pseudorandom factor.

A still further aspect of the present disclosure provides apparatus for receiving a plurality of data symbols. The apparatus comprises a processor and a memory. The memory contains instructions executable by the processor such that the apparatus is operable to receive a first on-off keyed signal corresponding to the data symbols. The first signal comprises a plurality of on periods and a plurality of off periods. Each on period comprises a first signal portion cyclically shifted within the on period by a respective random or pseudorandom factor.

An additional aspect of the present disclosure provides apparatus for transmitting a plurality of data symbols. The apparatus is configured to transmit a first on-off keyed signal corresponding to the data symbols. The first signal comprises a plurality of on periods and a plurality of off periods. Each on period comprises a first signal portion cyclically shifted within the on period by a respective random or pseudorandom factor.

A further aspect of the present disclosure provides apparatus for receiving a plurality of data symbols. The apparatus is configured to receive a first on-off keyed signal corresponding to the data symbols. The first signal comprising a plurality of on periods and a plurality of off periods. Each on period comprises a first signal portion cyclically shifted within the on period by a respective random or pseudorandom factor.

A still further aspect of the present disclosure provides apparatus for transmitting a plurality of data symbols. The apparatus comprises a transmitting module configured to transmit a first on-off keyed signal corresponding to the data symbols. The first signal comprising a plurality of on periods and a plurality of off periods. Each on period comprises a first signal portion cyclically shifted within the on period by a respective random or pseudorandom factor.

Another aspect of the present disclosure provides apparatus for receiving a plurality of data symbols. The apparatus comprises a receiving module configured to receive a first on-off keyed signal corresponding to the data symbols. The first signal comprising a plurality of on periods and a plurality of off periods. Each on period comprises a first signal portion cyclically shifted within the on period by a respective random or pseudorandom factor.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method of transmitting a plurality of data symbols;

FIG. 2 is a power spectral density graph for an example of a transmitted signal;

FIG. 3 is a power spectral density graph for another example of a transmitted signal;

FIG. 4 is a flow chart of an example of a method of receiving a plurality of data symbols;

FIG. 5 shows an example of apparatus for transmitting a plurality of data symbols;

FIG. 6 shows an example of apparatus for receiving a plurality of data symbols;

FIG. 7 shows an example of apparatus for transmitting a plurality of data symbols; and

FIG. 8 shows an example of apparatus for receiving a plurality of data symbols.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

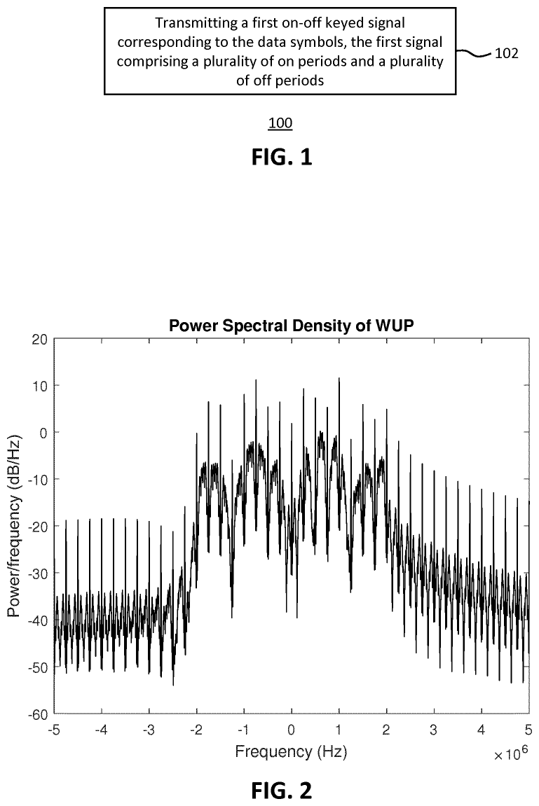

FIG. 1 is a flow chart of an example of a method 100 of transmitting a plurality of data symbols. The method comprises, in step 102, transmitting a first on-off keyed signal corresponding to the data symbols, the first signal comprising a plurality of on periods and a plurality of off periods. Each on period comprises a first signal portion cyclically shifted within the on period by a respective random or pseudorandom factor.

The cyclic shifting of the first signal portion may be performed within the on period. For example, the first signal portion may be shifted in the on period by a factor such as a delay or percentage, and any part of the first signal that is shifted outside of the on period may be reintroduced into the on period at the opposite end of the on period. In this way, for example, the on period may in some examples remain filled with a signal formed from the first signal portion.

In some examples, therefore, the first signal may have a flatter frequency response than other signals. In an example, Manchester coding may be applied to the data part of a wake up packet (WUP). For example, a logical “0” is encoded as “10” and a logical “1” as “01”. Therefore, every data symbol comprises an “ON” part (where there is energy) and an “OFF” part, where there is no energy, wherein the order of these parts is dependent on the data symbol. In addition, the WUP may be generated in some examples by means of an inverse fast Fourier transform (IFFT), as this block may already be available in some transmitters such as for example Wi-Fi transmitters supporting e.g. 802.11a/g/n/ac. An example approach for generating the OOK signal representing a WUP is to use the 13 sub-carriers in the center of an OFDM multi-carrier signal, and populating these 13 sub-carriers with a signal to represent ON and to not transmit anything at all to represent OFF. This may be referred to as multicarrier OOK (MC-OOK). In one example, the IFFT has 64 points and is operating at a sampling rate of 20 MHz, and just as for ordinary orthogonal frequency division multiplexing (OFDM) a cyclic prefix (CP) is added after the IFFT operation in order to have the OFDM symbol duration as being used in 802.11a/g/n/ac.

In some examples of MC-OOK for a WUP, the same OFDM symbol is used. In other words, the same frequency domain symbols are used to populate the non-zero subcarriers for all data symbols. Using the same OFDM symbol to generate the “ON” part of every Manchester coded data symbol may result in strong periodic time correlations in the data part of the WUP. These correlations give rise to spectral lines, which are spikes in the Power Spectral Density (PSD) of the WUP. These spectral lines may in some examples be undesirable because there may be local geographic regulations that limit the power that can be transmitted in narrow portions of the spectrum. An example PSD of an example WUP is shown in FIG. 2. In this example, the duration of the “ON” signal is Tₛ=4 μs, and spectral spikes arise at multiples of the fundamental frequency Fₛ=250 kHz=1/Tₛ.

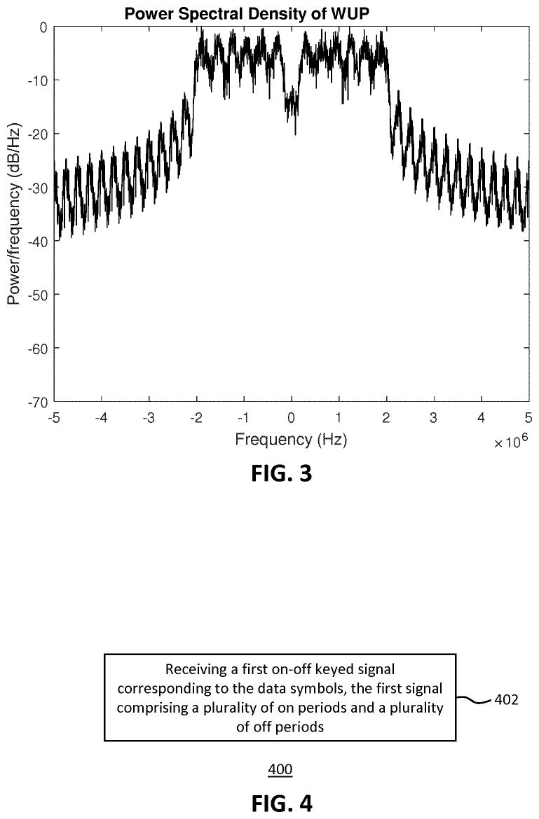

In some embodiments disclosed herein, the spectral density (e.g. PSD) of a plurality of transmitted data symbols, such as for example a wake up packet (WUP), may be flatter when compared to other data symbols, signals or packets. FIG. 3 shows an example of a PSD of a plurality of data symbols representing a WUP transmitted according to embodiments disclosed herein. The PSD shown in FIG. 3 is flatter than that shown in FIG. 2 and/or the spectral spikes are reduced or eliminated. Spectrum flatness may in some examples be desirable because some local geographic regulations may impose limitations on the maximum output power per MHz, and hence only a flat or flatter PSD may achieve the maximum allowed output power. In other embodiments, the transmitted data symbols may represent data other than a wake up packet (WUP), and/or different transmission parameters (e.g. number of subcarriers, frequencies, modulation schemes, symbols, code rates etc) may be used. As a result, the PSD may be different to the example shown in FIG. 3.

In some examples, the signal portion comprises at least a part of an OFDM symbol or at least one OFDM symbol. Therefore, each on period may comprise, for example, a cyclically shifted OFDM symbol or a cyclically shifted portion of an OFDM symbol.

In some examples, the first signal is transmitted from a first antenna. The method 100 may also include transmitting a second on-off keyed signal corresponding to the data symbols from a second antenna, the second signal comprising a plurality of on periods and a plurality of off periods, wherein each on period of the second signal comprises a second signal portion cyclically shifted in the on period by a respective random or pseudorandom factor.

The second signal, which represents the same data symbols as the first signal, may therefore provide diversity (e.g. spatial diversity) to the transmitted data symbols. In some examples, the first signal portion and the second signal portion are identical (e.g. the same OFDM symbol or a portion of the same OFDM symbol).

In other examples the first and second signal portions are different. For example, the second signal portion may be obtained by cyclically shifting the first signal portion, or the first and second signal portions may be unrelated.

In some examples, in each on period, the first and second signal portions may be cyclically shifted by the same factor when transmitted. However, in other examples, the first and second signal portions may be rotated by different factors (e.g. independently selected random or pseudorandom factors) when transmitted.

In some examples, the first signal comprises a multi-carrier signal. That is, for example, a signal portion may be transmitted on each of the subcarriers of the multi-carrier signal in the on period. In some examples, the same symbol or a portion of the same symbol is transmitted on each of the subcarriers in the on period. The signal in the on period may in some examples comprise an OFDM symbol or a portion of an OFDM symbol.

In some examples, the data symbols comprise at least part of a wake up packet (WUP), such as for example an 802.11ba WUP. Upon reception of the WUP, a receiver may for example wake another receiver and/or transmitter.

FIG. 4 is a flow chart of an example of a method 400 of receiving a plurality of data symbols. The method comprises, in step 402, receiving a first on-off keyed signal corresponding to the data symbols, the first signal comprising a plurality of on periods and a plurality of off periods. Each on period comprises a first signal portion cyclically shifted within the on period by a respective random or pseudorandom factor. In some examples, the first signal may be the first signal transmitted according to the method 100 of FIG. 1.

Some embodiments of this disclosure may be implemented in a network node, such as an access point (AP). For example, methods of transmitting may be implemented in a transmitting network node, and methods of receiving may be implemented in a receiving network node.

Particular examples of this disclosure are provided below.

In some examples, the signal transmitted or received represents a wake up packet (WUP). Suppose that the data part of the WUP consists of a number N of data symbols. A fixed set of K different delays is chosen, and for each of the data symbols a pseudo-random number m from 1 to K is generated. The m-th delay is applied cyclically to the OFDM symbol corresponding to the “ON” part the data symbol. This procedure may reduce or eliminate spectral lines (e.g. spikes) since it randomizes otherwise periodic patterns present in the transmitted signal.

In a first example embodiment, a signal is transmitted from a single antenna. Suppose that the data part of the WUP consists of a number N of OFDM symbols. This example embodiment consists of the following steps.
1. Determine a set of K delays, K≥2. These are {T₁^{CS}, . . . , T_{K}^{CS}}.
2. Generate a random or pseudorandom sequence consisting of N integers taking values between 1 and K. These are {m₁, . . . , m_{N}}.
3. Apply a random or pseudorandom cyclic shift to each of the OFDM symbols corresponding to the “ON” parts of the data symbols, wherein the cyclic shift corresponds to one of the N integers in the sequence. For example, apply the delay Tₘ_{ₙ}^{CS} (a negative value) to the OFDM symbol corresponding to the “ON” part of the n-th data symbol. That is, if s(t), 0≤t<Tₛ is the time domain signal corresponding to the “ON” part, having a duration T_{S}, then the cyclic shift s_{CS}(t; Tₘ_{ₙ}^{CS}) of s(t) by the delay Tₘ_{ₙ}^{CS}≤0 is generated by setting:

$${s}_{C S} ( t ; {T}_{{m}_{n}}^{C S} ) = \{ \begin{matrix}s ( t - {T}_{{m}_{n}}^{CS} ) if 0 \leq t < {T}_{s} + {T}_{{m}_{n}}^{CS} \\ s ( t - {T}_{{m}_{n}}^{CS} - {T}_{s} ) if {T}_{{m}_{n}}^{C S} + {T}_{s} \leq t < {T}_{s}\end{matrix}$$

4. Transmit the MC-OOK signal, comprising the cyclically shifted OFDM symbol s_{CS}(t; Tₘ_{ₙ}^{CS}) in the “ON” part of the n-th data symbol.

In one particular example, Tₛ=4 μs. A set of K=8 cyclic shifts {T₁^{CS}, . . . , T₈^{CS}} is defined as shown in the table below.

| | |
|---|---|
| T₁^{CS} | −0 ns |
| T₂^{CS} | −400 ns |
| T₃^{CS} | −800 ns |
| T₄^{CS} | −1200 ns |
| T₅^{CS} | −1600 ns |
| T₆^{CS} | −2000 ns |
| T₇^{CS} | −2400 ns |
| T₈^{CS} | −2800 ns |

In another particular example, Tₛ=2 μs. A set of K=8 cyclic shifts {T₁^{CS}, . . . , T₈^{CS}} is defined as shown in the table below.

| | |
|---|---|
| T₁^{CS} | −0 ns |
| T₂^{CS} | −400 ns |
| T₃^{CS} | −600 ns |
| T₄^{CS} | −800 ns |
| T₅^{CS} | −1000 ns |
| T₆^{CS} | −1200 ns |
| T₇^{CS} | −1400 ns |
| T₈^{CS} | −1800 ns |

A sequence of random or pseudorandom integers having values between 1 and 8 is generated for each data symbol, and a cyclic shift by the corresponding delay is applied to the “ON” part of the signal for each data symbol. For example, if Tₛ=2 μs and the integer mₙ generated for the n-th data symbol is 6, then a cyclic shift of T₆^{CS}=1200 ns is applied to the “ON” part of the n-th transmitted data symbol.

Any suitable method for pseudorandom sequence generation may be used. As an example, consider the case where K is a power of 2, i.e. K=2^{p}. The 802.11 standard utilizes the linear feedback shift register with generator polynomial z⁻⁷+z⁻⁴+1 to generate pseudorandom bit sequences. Any of these sequences can be used, by grouping the output in groups of p bits. Any such group can be mapped to an integer between 1 and K.

Another example embodiment involves transmission from multiple antennas (e.g. transmit diversity or spatial diversity). For each of the antennas, an MC-OOK signal is generated from data symbols according to any given multi-antenna transmit (TX) diversity technique. Then, the embodiment given for a single transmit antenna can be applied to a signal to be transmitted from each antenna. The TX diversity technique applied to the signals from the antennas may comprise delay diversity (e.g. as used in the GSM cellular system) or cyclic delay diversity (e.g. as used in the LTE cellular system).

In an example, suppose that there are L transmit antennas, MC-OOK is used, and CSD is the TX diversity technique employed by the transmitter. In this case, cyclic delays Δₗ, l=1, . . . , L are applied to the OFDM symbol s(t). Thus, the signal transmitted through the l-th antenna is s^{l}(t)=s_{CS}(t; Δₗ), where s_{CS}(t; Δₗ) denotes the cyclic shift of s(t) by Δₗ and is defined as given above for the single-antenna example. This example embodiment consists of the following steps.
1. Determine a set of K delays, K≥2. These are {T₁^{CS}, . . . , T_{K}^{CS}}.
2. Generate a random or pseudorandom sequence consisting of N integers taking values between 1 and K. These are {m₁, . . . , m_{N}}.
3. For each of the L antennas, apply the delay Tₘ_{ₙ}^{CS} (a negative value) to the OFDM symbol corresponding to the “ON” part of the n-th data symbol. That is, if s^{l}(t), 0≤t<Tₛ is the time domain signal corresponding to the “ON” part, then for the l-th antenna, the cyclic shift s_{CS}^{l}(t; Tₘ_{ₙ}^{CS}) of s^{l}(t) is generated by applying a cyclic delay by Tₘ_{ₙ}^{CS}. Note the delay Tₘ_{ₙ}^{CS} may change from one data symbol to the next.
4. Transmit the MC-OOK signal, comprising the cyclically shifted OFDM symbol s_{CS}^{l}(t; Tₘ_{ₙ}^{CS}) in the “ON” part of the n-th data symbol in the signal transmitted through the l-th antenna.

As an example, if CSD is used, then:

$${s}_{C S}^{l} ( t ; {T}_{{m}_{n}}^{CS} ) = s ( t ; {Δ}_{l} + {T}_{{m}_{n}}^{CS} ) = \{ \begin{matrix}s ( t - {Δ}_{l} - {T}_{{m}_{n}}^{CS} ) if 0 \leq t < {Δ}_{l} + {T}_{s} + {T}_{{m}_{n}}^{CS} \\ s ( t - {Δ}_{l} - {T}_{{m}_{n}}^{C S} - {T}_{s} ) if {Δ}_{l} + {T}_{{m}_{n}}^{C S} + {T}_{s} \leq t < {T}_{s}\end{matrix}$$

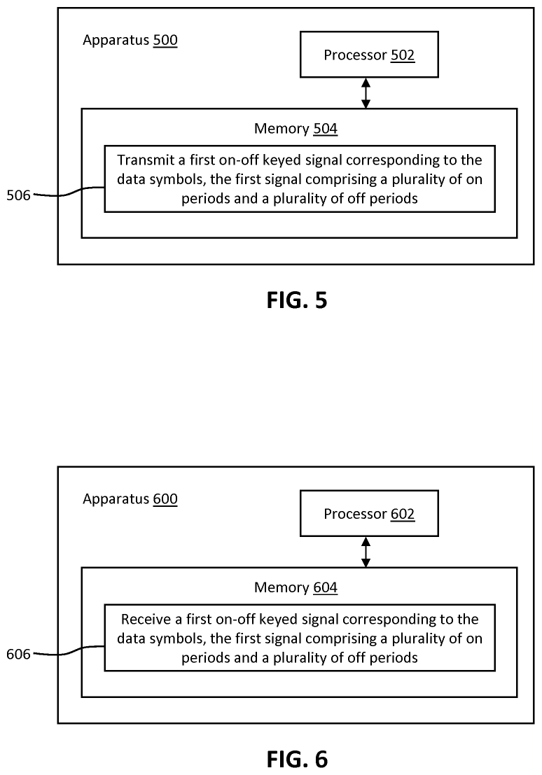

FIG. 5 shows an example of apparatus 500 for transmitting a plurality of data symbols. The apparatus 500 comprises a processor 502 and a memory 504. The memory 504 contains instructions 506 executable by the processor 502 such that the apparatus 500 is operable to transmit a first on-off keyed signal corresponding to the data symbols, the first signal comprising a plurality of on periods and a plurality of off periods. Each on period comprises a first signal portion cyclically shifted within the on period by a respective random or pseudorandom factor.

FIG. 6 shows an example of apparatus 600 for receiving a plurality of data symbols. The apparatus 600 comprises a processor 602 and a memory 604. The memory 604 contains instructions 606 executable by the processor 602 such that the apparatus 600 is operable to receive a first on-off keyed signal corresponding to the data symbols, the first signal comprising a plurality of on periods and a plurality of off periods. Each on period comprises a first signal portion cyclically shifted within the on period by a respective random or pseudorandom factor.

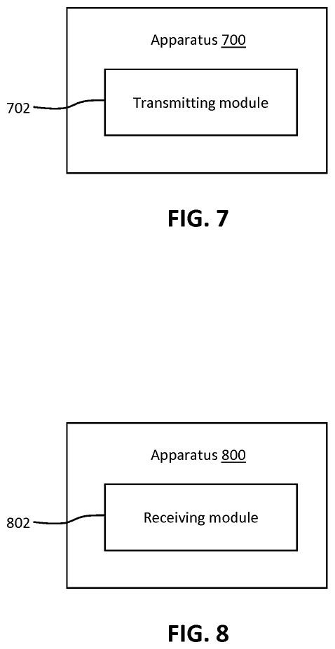

FIG. 7 shows an example of apparatus 700 for transmitting a plurality of data symbols. The apparatus 700 comprises a transmitting module 702 configured to transmit a first on-off keyed signal corresponding to the data symbols, the first signal comprising a plurality of on periods and a plurality of off periods. Each on period comprises a first signal portion cyclically shifted within the on period by a respective random or pseudorandom factor.

FIG. 8 shows an example of apparatus 800 for receiving a plurality of data symbols. The apparatus 800 comprises a receiving module 802 configured to receive a first on-off keyed signal corresponding to the data symbols, the first signal comprising a plurality of on periods and a plurality of off periods. Each on period comprises a first signal portion cyclically shifted within the on period by a respective random or pseudorandom factor.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1-31. (canceled)

32. A method of transmitting a plurality of data symbols, the method comprising:
transmitting a first on-off keyed signal corresponding to the data symbols, the first signal comprising a plurality of on periods and a plurality of off periods;
wherein each on period comprises a first signal portion cyclically shifted within the on period by a respective random or pseudorandom factor.

33. The method of claim 32, wherein the signal portion comprises at least a part of an OFDM symbol.

34. The method of claim 32, wherein the transmitting comprises transmitting the first signal from a first antenna.

35. The method of claim 34:
further comprising transmitting a second on-off keyed signal corresponding to the data symbols from a second antenna;
wherein the second signal comprises a plurality of on periods and a plurality of off periods; and
wherein each on period of the second signal comprises a second signal portion cyclically shifted in the on period by a respective random or pseudorandom factor.

36. The method of claim 35, wherein the first signal portion and the second signal portion are identical.

37. The method of claim 35, wherein the second signal portion is obtained by cyclically shifting the first signal portion.

38. The method of claim 32, wherein the first signal comprises a multi-carrier signal.

39. The method of claim 32:
wherein each data symbol corresponds to an on period and an off period in a respective symbol period; and
wherein an order of the on period and the off period in each symbol period is based on the data symbol corresponding to the symbol period.

40. The method of claim 39, wherein the order of the on period and the off period in each symbol period is selected based on Manchester coding of the corresponding data symbol.

41. The method of claim 32, wherein the data symbols comprise at least part of a wake up packet (WUP).

42. The method of claim 41, wherein the data symbols comprise at least part of an IEEE 802.11ba wake up packet (WUP).

43. A method of receiving a plurality of data symbols, the method comprising:
receiving a first on-off keyed signal corresponding to the data symbols, the first signal comprising a plurality of on periods and a plurality of off periods;
wherein each on period comprises a first signal portion cyclically shifted within the on period by a respective random or pseudorandom factor.

44. The method of claim 43, wherein the signal portion comprises at least a part of an OFDM symbol.

45. The method of claim 43, wherein the first signal comprises a multi-carrier signal.

46. The method of claim 43:
wherein each data symbol corresponds to an on period and an off period in a respective symbol period; and
wherein an order of the on period and the off period in each symbol period is based on the data symbol corresponding to the symbol period.

47. The method of claim 46, wherein the order of the on period and the off period in each symbol period is selected based on Manchester coding of the corresponding data symbol.

48. The method of claim 43, wherein the data symbols comprise at least part of a wake up packet (WUP).

49. The method of claim 48, wherein the data symbols comprise at least part of an IEEE 802.11ba wake up packet (WUP).

50. The method of claim 48, further comprising waking up a device upon receipt of the WUP.

51. The method of claim 50, wherein the device is an IEEE 802.11 receiver.

52. An apparatus for transmitting a plurality of data symbols, the apparatus comprising:
processing circuitry;
memory containing instructions executable by the processing circuitry whereby the apparatus is operative to:
transmit a first on-off keyed signal corresponding to the data symbols, the first signal comprising a plurality of on periods and a plurality of off periods;
wherein each on period comprises a first signal portion cyclically shifted within the on period by a respective random or pseudorandom factor.

53. An apparatus for receiving a plurality of data symbols, the apparatus comprising a processor and a memory, the memory containing instructions executable by the processor such that the apparatus is operable to:
processing circuitry;
memory containing instructions executable by the processing circuitry whereby the apparatus is operative to:
receive a first on-off keyed signal corresponding to the data symbols, the first signal comprising a plurality of on periods and a plurality of off periods;
wherein each on period comprises a first signal portion cyclically shifted within the on period by a respective random or pseudorandom factor.

54. A non-transitory computer readable recording medium storing a computer program product for handling transmission of a plurality of data symbols, the computer program product comprising program instructions which, when run on processing circuitry of an apparatus, causes the apparatus to:
transmit a first on-off keyed signal corresponding to the data symbols, the first signal comprising a plurality of on periods and a plurality of off periods;
wherein each on period comprises a first signal portion cyclically shifted within the on period by a respective random or pseudorandom factor.

55. A non-transitory computer readable recording medium storing a computer program product for handling reception of a plurality of data symbols, the computer program product comprising program instructions which, when run on processing circuitry of an apparatus, causes the apparatus to:
receive a first on-off keyed signal corresponding to the data symbols, the first signal comprising a plurality of on periods and a plurality of off periods;
wherein each on period comprises a first signal portion cyclically shifted within the on period by a respective random or pseudorandom factor.
